(19) United States
(12) Patent Application Publication
(10) Pub. No.: US 2026/0147981 A1
(43) Pub. Date: May 28, 2026

(54) INFORMATION PROCESSING APPARATUS, INFORMATION PROCESSING METHOD, AND NON-TRANSITORY COMPUTER-READABLE MEDIUM

(71) Applicant: NEC Corporation, Tokyo (JP)

(72) Inventors: Bo YANG, Tokyo (JP); Tasuku KITADE, Tokyo (JP); Masanori TSUJIKAWA, Tokyo (JP)

(73) Assignee: NEC Corporation, Tokyo (JP)

(21) Appl. No.: 19/387,951

(22) Filed: Nov. 13, 2025

(30) Foreign Application Priority Data
Nov. 25, 2024 (JP) 2024-204659

(51) Int. Cl. G06F 40/166; G06F 40/295; G06F 40/40

(52) U.S. Cl. CPC G06F 40/166; G06F 40/295; G06F 40/40

(57) ABSTRACT

An information processing apparatus performs: estimating, for each of a plurality of topics in a conversation history, a partial conversation history related to the topic in the conversation history; generating a partial summary sentence from the partial conversation history; and generating a summary document of the conversation history based on the partial summary sentence for each of the plurality of topics. The information processing apparatus can support a user's decision making based on the summary document.

### INCORPORATION BY REFERENCE

This application is based upon and claims the benefit of priority from Japanese patent application No. 2024-204659, filed on Nov. 25, 2024, the disclosure of which is incorporated herein in its entirety by reference.

### TECHNICAL FIELD

The present disclosure relates to an information processing apparatus, an information processing method, and an information processing program.

### BACKGROUND ART

JP 5728374 describes a technique for generating summary data from a conversation history. The technique extracts a statement (utterance) having the highest score in the conversation history as an important sentence, and repeats adding scores to statements included in a block including the important sentence and neighboring blocks to generate summary data including the extracted important sentence.

### SUMMARY

In the technique described in JP 5728374, there is a problem that summary data is simply generated from an important sentence having a high score, and appropriate summary data may not be generated from, for example, a conversation history having a plurality of viewpoints to be regarded as important. The present disclosure has been made in view of the above problems, and an example object thereof is to provide a technique for generating a more appropriate summary document from a conversation history.

An information processing apparatus according to an example aspect of the present disclosure performs: estimating, for each of a plurality of topics in a conversation history, a partial conversation history related to the topic in the conversation history; generating a partial summary sentence from the partial conversation history; and generating a summary document of the conversation history based on the partial summary sentence for each of the plurality of topics.

An information processing method according to an example aspect of the present disclosure, performed by at least one computer, includes: estimating, for each of a plurality of topics in a conversation history, a partial conversation history related to the topic in the conversation history; generating a partial summary sentence from the partial conversation history; and generating a summary document of the conversation history based on the partial summary sentence for each of the plurality of topics.

A non-transitory computer-readable medium according to an example aspect of the present disclosure is configured to store a program that causes at least one computer to execute: estimating, for each of a plurality of topics in a conversation history, a partial conversation history related to the topic in the conversation history; generating a partial summary sentence from the partial conversation history; and generating a summary document of the conversation history based on the partial summary sentence for each of the plurality of topics.

According to an exemplary aspect of the present disclosure, there is an exemplary effect that a technique for generating a more appropriate summary document from a conversation history can be provided.

### BRIEF DESCRIPTION OF DRAWINGS

FIG. 1 is a block diagram illustrating a configuration of an information processing apparatus according to the present disclosure;

FIG. 2 is a flowchart illustrating a flow of an information processing method according to the present disclosure;

FIG. 3 is a diagram schematically illustrating an outline of an information processing system according to the present disclosure;

FIG. 4 is a block diagram illustrating a configuration of an information processing system according to the present disclosure;

FIG. 5 is a flowchart illustrating a flow of the information processing method according to the present disclosure;

FIG. 6 is a diagram schematically illustrating estimation processing in an application example of the present disclosure;

FIG. 7 is a diagram schematically illustrating first extraction processing in an application example of the present disclosure;

FIG. 8 is a diagram schematically illustrating an example of relationship information in an application example of the present disclosure;

FIG. 9 is a diagram schematically illustrating an example of a medical report in an application example of the present disclosure;

FIG. 10 is a diagram schematically illustrating an outline of an information processing system according to the present disclosure;

FIG. 11 is a block diagram illustrating a configuration of an information processing system according to the present disclosure;

FIG. 12 is a flowchart illustrating a flow of an information processing method according to the present disclosure;

FIG. 13 is a block diagram illustrating a configuration of the information processing system according to the present disclosure; and

FIG. 14 is a block diagram illustrating a hardware configuration of a computer that functions as each apparatus according to the present disclosure.

### EXAMPLE EMBODIMENT

Hereinafter, example embodiments of the present invention will be exemplified. However, the present invention is not limited to the following exemplary example embodiments, and various modifications can be made within a scope described in the claims. For example, example embodiments obtained by appropriately combining techniques (some or all of things or methods) adopted in the following exemplary example embodiments can also be included in the scope of the present invention. Example embodiments obtained by appropriately omitting some of the techniques adopted in the following exemplary example embodiments can also be included in the scope of the present invention. Effects mentioned in the following exemplary example embodiments are examples of effects expected in the exemplary example embodiments, and do not define extension of the present invention. In other words, example embodiments that do not provide the effects mentioned in each of the following exemplary example embodiments can also be included in the scope of the present invention.

### First Exemplary Example Embodiment

A first exemplary example embodiment that is an example of the example embodiments of the present invention will be described in detail with reference to the drawings. The present exemplary example embodiment is a basic form of each exemplary example embodiment to be described below. An application range of each technique adopted in the present exemplary example embodiment is not limited to the present exemplary example embodiment. That is, each technique adopted in the present exemplary example embodiment can also be adopted in another exemplary example embodiment included in the present disclosure within a range in which no particular technical problem occurs. Each technique illustrated in the drawings referred to for describing the present exemplary example embodiment may also be adopted in another exemplary example embodiment included in the present disclosure within a range in which no particular technical problem occurs.

### Configuration of Information Processing Apparatus 1

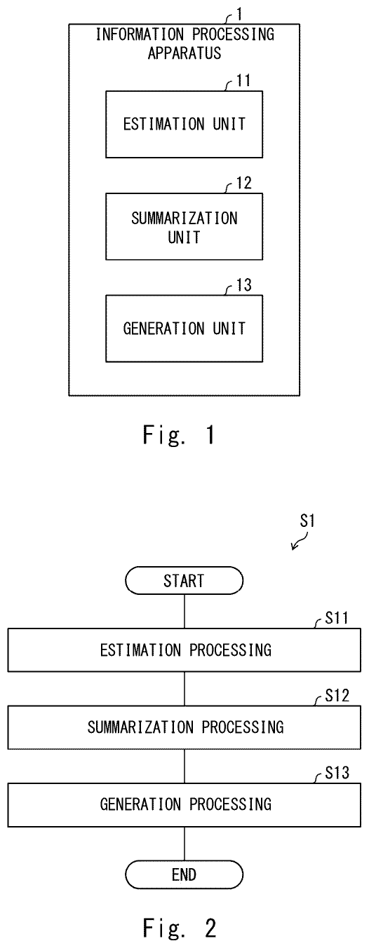

A configuration of an information processing apparatus 1 will be described with reference to FIG. 1. FIG. 1 is a block diagram illustrating a configuration of the information processing apparatus 1. As illustrated in FIG. 1, the information processing apparatus 1 includes an estimation unit 11, a summarization unit 12, and a generation unit 13. The estimation unit 11 is an example of a configuration for implementing an estimation means. The summarization unit 12 is an example of a configuration for implementing a summarization means. The generation unit 13 is an example of a configuration for implementing a generation means.

The estimation unit 11 estimates, for each of a plurality of topics in a conversation history, a partial conversation history related to the topic of the conversation history. Here, the conversation history indicates a sequence in which utterances in a conversation performed among a plurality of speakers are arranged in the order of utterance. For example, the conversation history is represented by text data indicating a natural language sentence. For example, such text data may be obtained by converting voice data indicating conversation into text data, but is not limited thereto.

Furthermore, the partial conversation history is desirably generated in such a way as to include continuous utterances in the original conversation history. However, in the partial conversation history, all the utterances constituting the partial conversation history may not be continuous in the original conversation history, and the lower limit number of utterances to be continuous may be defined. For example, in a case where the utterances 1 to 10 are included in the conversation history in this order and the number of the utterances to be continuous is three, it may be allowed to estimate the utterances 1 to 3 and 7 to 10 as the partial conversation history related to a certain topic since at least three continuous utterances are included.

For example, the estimation unit 11 may generate a partial conversation history for each of a plurality of topics from the conversation history by using a large-scale language model. In this case, for example, the estimation unit 11 may generate the partial conversation history of each of the plurality of topics by inputting a prompt including the conversation history and the instruction to generate the partial conversation history of each of the plurality of topics to the large-scale language model.

Furthermore, for example, the estimation unit 11 may estimate which of a plurality of topics each utterance included in the conversation history is, and may generate a partial conversation history by collecting utterances whose estimated topics are the same. For example, in a case where the plurality of topics are not determined in advance, a large-scale language model may be used in the processing of estimating the topic of each utterance. Furthermore, for example, in a case where a plurality of topics are determined in advance, a classification model may be used or a large-scale language model may be used in the processing of estimating the topic of each utterance. However, the method of generating the partial conversation history is not limited to the above-described example.

The summarization unit 12 generates a partial summary sentence from the partial conversation history. For example, the summarization unit 12 may generate a partial summary sentence from the partial conversation history by using a large-scale language model. In this case, for example, the summarization unit 12 may generate the partial summary sentence by inputting a prompt including the partial conversation history and a summary instruction thereof to the large-scale language model. However, the method of generating the partial summary sentence is not limited to the above-described example, and other known methods may be adopted.

In a case where a large-scale language model is used in one or both of the estimation unit 11 and the summarization unit 12, the large-scale language model may be a general-purpose large-scale language model, or may be a large-scale language model fine-tuned using training data of a field related to the conversation history. Furthermore, in a case where the large-scale language model is used in both the estimation unit 11 and the summarization unit 12, the same large-scale language model may be used, or different large-scale language models may be used.

The generation unit 13 generates a summary document of the conversation history based on the partial summary sentence for each of the plurality of topics. For example, the generation unit 13 may generate a summary document of the conversation history by combining partial summary sentences for each of a plurality of topics. Furthermore, for example, the generation unit 13 may configure the summary document with a plurality of sections. In this case, the generation unit 13 may arrange a natural language sentence indicating a topic related to the section among the plurality of topics as the title of each section, and arrange a partial summary sentence for the topic as the content of the section. In addition, the generation unit 13 may generate a summary document from the partial summary sentences for each of a plurality of topics by using a large-scale language model. However, the method of generating the summary document is not limited to the above-described example.

### Effect of Information Processing Apparatus 1

As described above, in the information processing apparatus 1, a configuration is adopted that includes the estimation unit 11 for estimating, for each of a plurality of topics in a conversation history, a partial conversation history related to the topic in the conversation history, the summarization unit 12 for generating a partial summary sentence from the partial conversation history, and the generation unit 13 for generating a summary document of the conversation history based on the partial summary sentence for each of the plurality of topics. Therefore, according to the information processing apparatus 1, since a plurality of topics in the conversation history are considered, an effect is obtained in that a more appropriate summary document can be generated from the conversation history.

### Flow of Information Processing Method S1

A flow of an information processing method S1 will be described with reference to FIG. 2. For example, in a case where the information processing apparatus 1 includes at least one processor, the information processing apparatus 1 executes the information processing method S1. FIG. 2 is a flowchart illustrating the flow of the information processing method S1. As illustrated in FIG. 2, the information processing method S1 includes an estimation processing S11, a summarization processing S12, and a generation processing S13.

In the estimation processing S11, at least one processor (e.g., the estimation unit 11) estimates, for each of a plurality of topics in a conversation history, a partial conversation history related to the topic in the conversation history. For example, details of the estimation processing S11 are described similarly to the estimation unit 11, and thus detailed description will not be repeated.

In the summarization processing S12, at least one processor (e.g., the summarization unit 12) generates a partial summary sentence from the partial conversation history. For example, details of the summarization processing S12 are described similarly to the summarization unit 12, and thus detailed description will not be repeated.

In the generation processing S13, at least one processor (e.g., the generation unit 13) generates a summary document of the conversation history based on the partial summary sentence for each of the plurality of topics. For example, details of the generation processing S13 are described similarly to the generation unit 13, and thus detailed description will not be repeated.

### Effects of Information Processing Method

As described above, in the information processing method S1, a configuration is adopted that includes the estimation processing S11 in which at least one processor estimates, for each of a plurality of topics in a conversation history, a partial conversation history related to the topic in the conversation history, the summarization processing S12 in which the at least one processor generates a partial summary sentence from the partial conversation history, and the generation processing S13 in which the at least one processor generates a summary document of the conversation history based on partial summary sentences for each of the plurality of topics. Therefore, according to the information processing method S1, the same effects as those of the information processing apparatus 1 can be obtained.

### Second Exemplary Example Embodiment

A second exemplary example embodiment that is an example of the example embodiments of the present invention will be described in detail with reference to the drawings. Components that have the same functions as those of the components described in the above-described exemplary example embodiment are denoted by the same reference signs, and will not be described as appropriate. An application range of each technique adopted in the present exemplary example embodiment is not limited to the present exemplary example embodiment. That is, each technique adopted in the present exemplary example embodiment can also be adopted in another exemplary example embodiment included in the present disclosure within a range in which no particular technical problem occurs. Each technique illustrated in each of the drawings referred to for describing the present exemplary example embodiment can be adopted in the other exemplary example embodiments included in the present disclosure within a range in which no particular technical problem occurs.

### Outline of Information Processing System 100a

The information processing system 100A is a system for generating a summary document conforming to a predetermined format from a conversation history. For example, the information processing system 100A estimates a plurality of topics from the conversation history, and estimates to which of the plurality of topics each utterance included in the conversation history is related to estimate the partial conversation history related to each topic. Furthermore, the information processing system 100A extracts a keyword from the partial conversation history related to each topic, generates a partial summary sentence related to each topic based on the extracted keyword and the partial conversation history, and generates a summary document conforming to a predetermined format based on each generated partial summary sentence.

Here, the summary document generated by the information processing system 100A is a document conforming to a predetermined format including a plurality of sections. The predetermined format indicates, for example, a plurality of sections to be included in the summary document. Furthermore, the predetermined format may further indicate the hierarchical structure of the sections, the order of the sections, and the like, but is not limited thereto. Examples of the document conforming to the predetermined format include, for example, a medical report, a call reception record of a call center, a reception record at a counter of a financial institution, and the like. For example, there is a case where a predetermined format including a plurality of sections such as “disease name and disease state”, “purpose of surgery”, and the like is defined in a treatment manual that is one of medical reports. Therefore, such a medical report is an example of a document conforming to a predetermined format. The document conforming to the predetermined format is not limited to the above-described example.

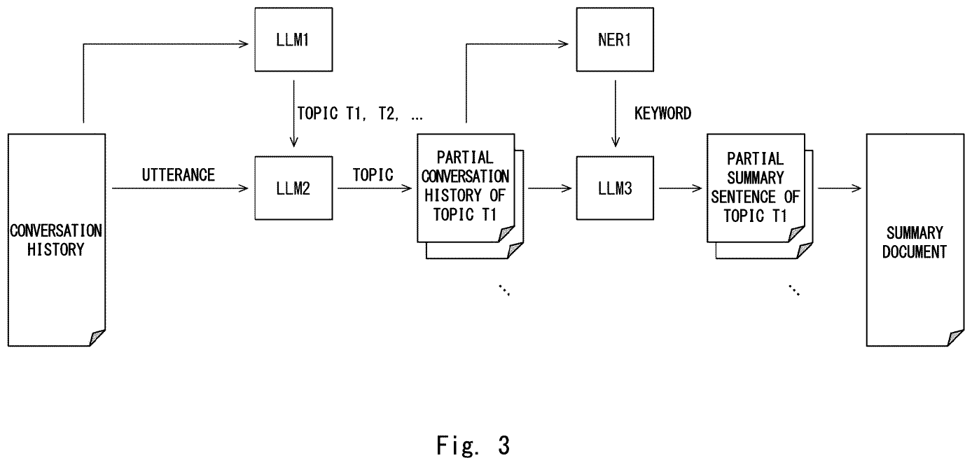

FIG. 3 is a diagram schematically illustrating an outline of the information processing system 100A. As illustrated in FIG. 3, a plurality of topics T1, T2, . . . are estimated from the conversation history using the large-scale language model LLM1. Furthermore, for each utterance constituting the conversation history, to which topic among the plurality of topics T1, T2, . . . it is related is estimated by using the large-scale language model LLM2. Furthermore, the partial conversation history of the topic T1, the partial conversation history of the topic T2, . . . are generated by collecting the utterances whose estimated topics are the same. Furthermore, one or a plurality of keywords is extracted from the partial conversation history of each topic using a named entity recognition model NER1. In addition, a partial summary sentence is generated using a large-scale language model LLM3 from each partial conversation history and one or a plurality of keywords extracted from the partial conversation history. Furthermore, the summary document of the entire conversation history is generated based on the partial summary sentence for each of the plurality of topics generated in this manner.

### Configuration of Information Processing System 100A

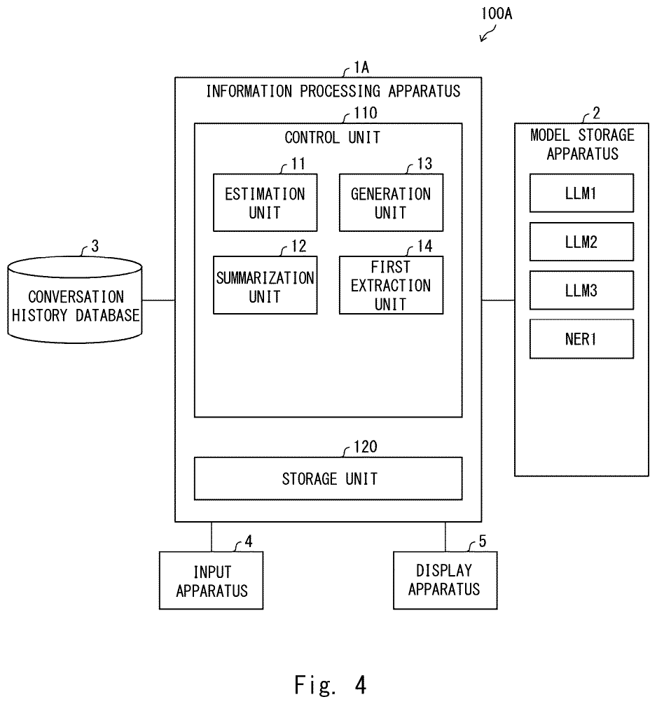

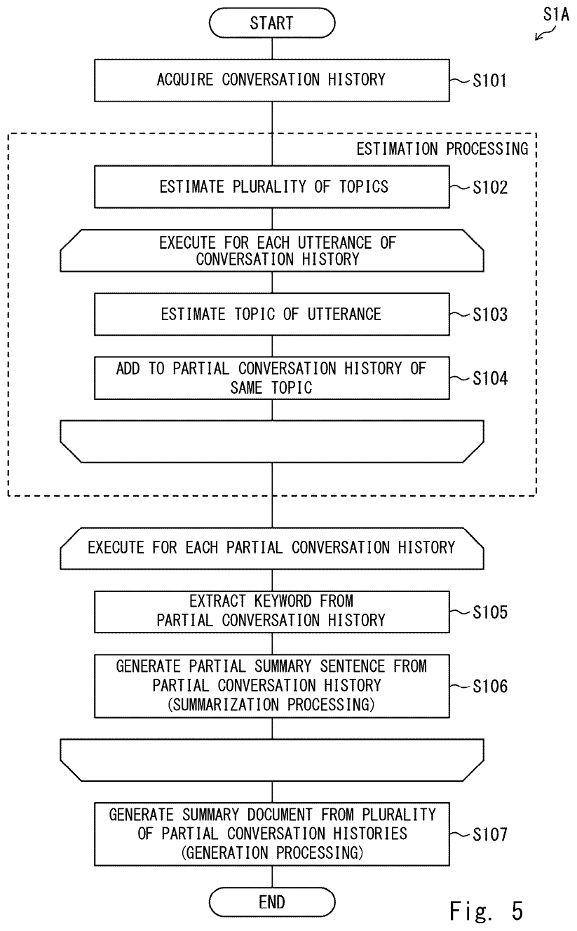

A configuration of the information processing system 100A will be described with reference to FIG. 4. FIG. 4 is a block diagram illustrating the configuration of the information processing system 100A. As illustrated in FIG. 4, the information processing system 100A includes an information processing apparatus 1A, a model storage apparatus 2, a conversation history database 3, an input apparatus 4, and a display apparatus 5. The information processing apparatus 1A is communicably connected to the model storage apparatus 2, the conversation history database 3, the input apparatus 4, and the display apparatus 5 via a network, a peripheral apparatus connection interface, or the like. Some or all of the information stored in the model storage apparatus 2 and the conversation history database 3 may be stored in a storage unit 120 of the information processing apparatus 1A. Furthermore, one or both of the input apparatus 4 and the display apparatus 5 may be built in the information processing apparatus 1A instead of being connected to the information processing apparatus 1A. In addition, the input apparatus 4 and the display apparatus 5 may be connected to or built in a user terminal (not illustrated), and the user terminal may be communicably connected to the information processing apparatus 1A via a network. Although FIG. 4 illustrates one of each of the model storage apparatus 2, the conversation history database 3, the input apparatus 4, and the display apparatus 5, the information processing system 100A may include a plurality of some or all of these apparatuses.

### Model Storage Apparatus 2

The model storage apparatus 2 stores large-scale language models LLM1 to LLM3 and a named entity recognition model NER1. Each of the large-scale language models LLM1 to LLM3 is a deep learning model generated to execute a natural language processing task. For example, the large-scale language models LLM1 to LLM3 are models that execute a sentence generation task, and are models that output a generated natural language sentence with a prompt by the natural language sentence as an input. Each of the large-scale language models LLM1 to LLM3 may be a model obtained by fine-tuning a general-purpose large-scale language model or may be a general-purpose large-scale language model. In a case where at least one of the large-scale language models LLM1 to LLM3 is a general-purpose large-scale language model, in-context learning may be performed using the large-scale language model. In addition, at least two of the large-scale language models LLM1 to LLM3 may be the same model or may be different models.

The named entity recognition model NER1 is a model that outputs a word or a word string and a label as a named entity in an input natural language sentence. For example, the named entity recognition model NER1 may be a general-purpose named entity recognition model or may be a named entity recognition model fine-tuned in such a way that a named entity of a label specific to a field related to a conversation history can be recognized.

### Conversation History Database 3

The conversation history database 3 stores a conversation history. The conversation history is text data represented by a natural language sentence indicating a conversation among a plurality of speakers. Furthermore, for example, the conversation history may be stored as a sequence of text data in units of utterances, and identification information indicating a speaker may be associated with each utterance. Furthermore, for example, the conversation history may be converted from voice data in which a conversation among a plurality of speakers is recorded.

### Input Apparatus 4 and Display Apparatus 5

The input apparatus 4 is a configuration for accepting an input to the information processing apparatus 1A, and may include, as an example, an input apparatus such as a keyboard, a mouse, a touch panel, a camera, or a microphone. The display apparatus 5 is a configuration for displaying a screen output from the information processing apparatus 1A, and may include a display as an example. Furthermore, the input apparatus 4 and the display apparatus 5 may be integrally formed as a touch panel or the like.

### Configuration of Information Processing Apparatus 1A

As illustrated in FIG. 4, the information processing apparatus 1A includes a control unit 110 and a storage unit 120. The control unit 110 integrally controls each unit of the information processing apparatus 1A. The storage unit 120 stores various data and programs referred to by the control unit 110.

The control unit 110 includes a first extraction unit 14 in addition to the estimation unit 11, the summarization unit 12, and the generation unit 13 included in the information processing apparatus 1. The first extraction unit 14 is an example of a configuration for implementing a first extraction means.

The estimation unit 11 is configured as follows in addition to being configured similar to that in the first exemplary example embodiment. The estimation unit 11 estimates a plurality of topics based on the conversation history, and estimates the partial conversation history for each of the plurality of estimated topics. As a result, a plurality of topics for which the partial conversation history is to be generated can be more appropriately estimated. Furthermore, the estimation unit 11 estimates which of a plurality of topics each utterance included in the conversation history relates to, and estimates, as the partial conversation history, the utterances whose estimated topics are the same. As a result, the partial conversation history can be generated more appropriately from the conversation history.

For example, the estimation unit 11 estimates a plurality of topics from the conversation history by using the large-scale language model LLM1. For example, the estimation unit 11 may estimate a plurality of topics to be output by inputting a prompt including a conversation history and an estimation instruction of a plurality of topics to the large-scale language model LLM1.

Furthermore, for example, the estimation unit 11 estimates which of a plurality of topics each utterance included in the conversation history relates to by using the large-scale language model LLM2. For example, the estimation unit 11 may estimate the topic of the utterance by inputting a prompt including one utterance and an estimation instruction as to which of a

### Plurality of Topics to the Large-Scale Language Model LLM2

Furthermore, for example, the estimation unit 11 may generate the partial conversation history for each of the plurality of topics by executing, for each utterance included in the conversation history, processing of adding the utterance to the partial conversation history of the estimated topic in the order included in the conversation history.

The first extraction unit 14 extracts a keyword from the partial conversation history. For example, the first extraction unit 14 may extract a keyword from the partial conversation history by using the named entity recognition model NER1. In other words, the named entity output by inputting the partial conversation history to the named entity recognition model NER1 is extracted as the keyword in the partial conversation history. The first extraction unit 14 extracts a keyword for the partial conversation history for each of the plurality of topics.

The summarization unit 12 is configured as follows in addition to being configured similar to that in the first exemplary example embodiment. The summarization unit 12 generates a partial summary sentence based on the partial conversation history and the keyword. For example, the summarization unit 12 may generate a partial summary sentence based on the partial conversation history and the keyword by using the large-scale language model LLM3. In other words, a sentence output by inputting a prompt including the partial conversation history, the keyword, and the instruction to summarize the partial conversation history based on the keyword to the large-scale language model LLM3 may be acquired as the partial summary sentence. As a result, a more appropriate partial summary sentence is generated as compared with a case where the partial conversation history is simply input to the large-scale language model.

The generation unit 13 is configured as follows in addition to being configured similar to that in the first exemplary example embodiment. The generation unit 13 generates a summary document with reference to relationship information indicating a relationship between at least one of a plurality of topics and at least one of a plurality of sections. The plurality of sections are a plurality of sections to be included in the summary document indicated by a predetermined format defined in the summary document.

For example, the relationship information may be information in which one or more topics among a plurality of topics are associated with respect to each of a plurality of sections. For example, the section and the topic are not limited to a one-to-one relationship, and a plurality of topics may be associated with one section, or a plurality of sections may be associated with one topic.

For example, the generation unit 13 may include a title defined for each section and a partial summary sentence of one or a plurality of topics associated with the section in the summary document as the section. Thus, an appropriate summary document conforming to a predetermined format can be generated.

### Flow of Information Processing Method S1A

The information processing system 100A configured as described above executes an information processing method S1A. FIG. 5 is a flowchart illustrating the flow of the information processing method S1A. As illustrated in FIG. 5, the information processing method S1A includes steps S101 to S107.

In step S101, the control unit 110 of the information processing apparatus 1A acquires the conversation history from the conversation history database 3.

Steps S102 to S104 are an example of the estimation processing. In step S102, the estimation unit 11 estimates a plurality of topics in the conversation history by using the large-scale language model LLM1.

Steps S103 to S104 are processing executed for each utterance included in the conversation history in the order included in the conversation history.

In step S103, the estimation unit 11 estimates which of the plurality of topics estimated in step S102 the topic related to the corresponding utterance is, by using the large-scale language model LLM2.

In step S104, the estimation unit 11 adds the utterance to the partial conversation history for the estimated topic.

If steps S103 to S104 are completed for all the utterances included in the conversation history, next steps S105 to S106 are executed. Steps S105 to S106 are processing executed for each of the plurality of partial conversation histories.

In step S105, the first extraction unit 14 extracts a keyword from the corresponding partial conversation history by using the named entity recognition model NER1.

Step S106 is an example of the summarization processing. The summarization unit 12 generates a partial summary sentence based on the partial conversation history and the keyword by using the large-scale language model LLM2.

If steps S105 to S106 are completed for all the partial conversation histories, a next step S107 is executed.

Step S107 is an example of the generation processing. In step S107, the generation unit 13 generates the summary document based on the plurality of partial conversation histories with reference to the relationship information.

Thus, the information processing method S1A ends.

### Application Example

As an application example of the information processing system 100A, an example in which the summary document is a medical report will be described. In addition, an example in which the predetermined format is a format defined as a treatment manual will be described. In the present application example, in step S101, a conversation history between the doctor and the patient as well as his/her family is acquired.

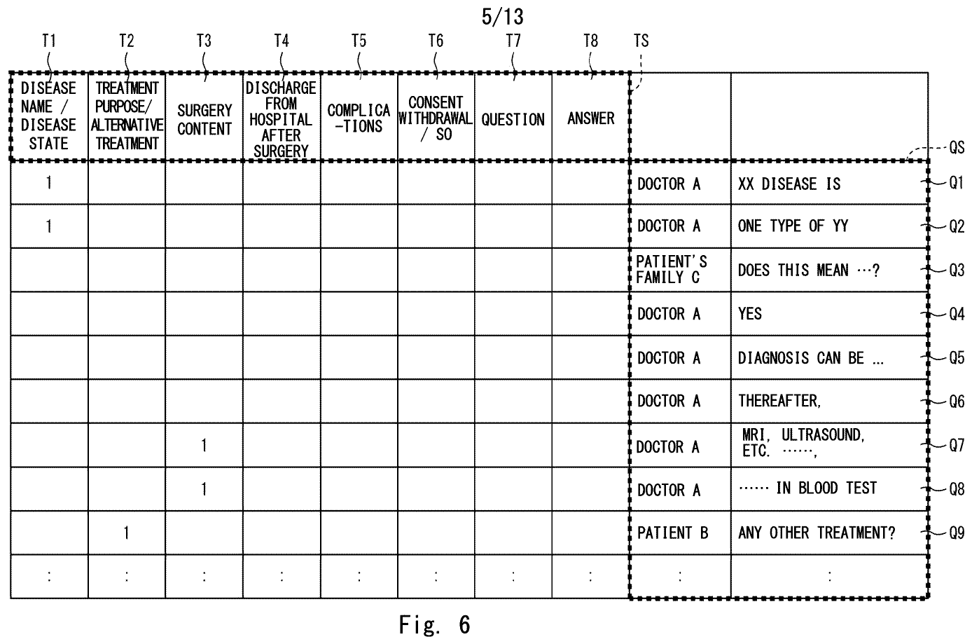

In steps S102 to S104, a plurality of partial conversation histories are estimated from the conversation history. FIG. 6 is a diagram schematically illustrating estimation processing in the present application example. As illustrated in FIG. 6, in the present application example, in step S102, eight topics T1 “disease name/disease state”, T2 “treatment purpose/alternative treatment”, T3 “surgery content”, T4“discharge from hospital after surgery”, T5 “complication”, T6 “consent withdrawal/SO”, T7 “question”, and T8 “answer” existing in the conversation history are estimated. As the estimation processing of the topics T1 to T8, a topic defined in advance may be estimated, or a topic not defined in advance may be estimated.

Furthermore, as illustrated in FIG. 6, the conversation history includes utterances Q1 to Q9, . . . in this order. Each utterance is associated with “doctor A”, “patient B”, “patient's family C”, and the like as speakers. In step S103, which of the topics T1 to T8 the utterances Q1 to Q9 are related to is estimated. 1 described in a cell in the table in which the topic is the column item TS and the utterance is the row item QS indicates that the topic has been estimated for the utterance. For example, the utterances Q1 and Q2 “XX disease is a type of YY” are estimated to be related to the topic T1 “disease name/disease state”. For example, the utterances Q7 and Q8 “MRI, ultrasound, etc. · · · blood test · · · ” are estimated to be related to the topic T3 “surgery content”. Furthermore, the utterance Q9 “Any other treatment?” is estimated to be related to the topic T2 “treatment purpose/alternative treatment”. The utterances Q3 to Q6 for which no topic has been estimated may be included in the partial conversation history for the same topic as the topic immediately before or immediately after, or may not be included in any partial conversation history.

In step S104, the utterances Q1 to Q9, . . . are added to the partial conversation history for the estimated topic among the topics T1 to T8, respectively. As a result, a partial conversation history is generated for each of the topics T1 to T8.

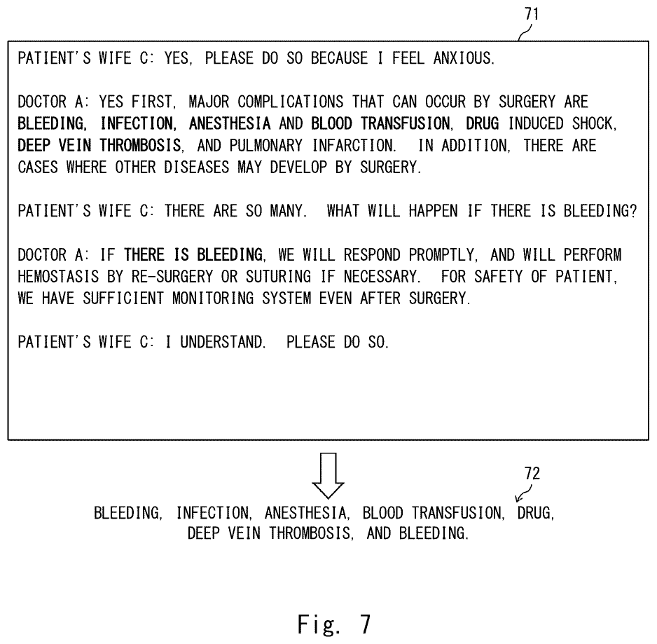

In step S105, the keyword is extracted by the first extraction unit 14 from the partial conversation history for each of the topics T1 to T8. FIG. 7 is a diagram schematically illustrating a first extraction processing in the present application example. In FIG. 7, a partial conversation history 71 indicates, for example, a partial conversation history for the topic T5 “complication”. A keyword 72 is extracted as a named entity included in the partial conversation history 71 by the named entity recognition model NER1. As the named entity recognition model NER1, a model fine-tuned by training data in the medical field is used. As the training data, for example, a case of a conversation history between a doctor, and a patient as well as his/her family accumulated in the past may be used.

In step S106, a partial summary sentence is generated for each of the topics T1 to T8 based on the partial conversation history 71 and the keyword 72.

In step S107, the relationship information is referenced to generate the medical report.

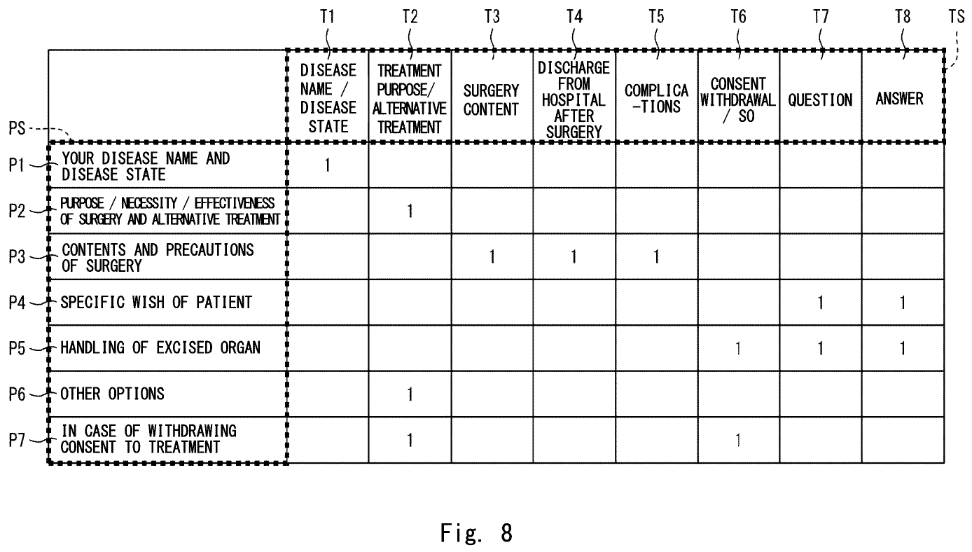

FIG. 8 is a diagram schematically illustrating an example of relationship information in the present application example. As illustrated in FIG. 8, in the present application example, the medical report serving as the summary document is defined to include, as the format of the treatment manual, a section P1 “your disease name and disease state”, a section P2 “purpose/necessity/effectiveness of surgery and alternative treatment”, a section P3 “contents and precautions of surgery”, a section P4 “patient's specific wish”, a section P5 “handling of excised organ”, a section P6 “options other than the above”, and a section P7 “in a case of withdrawing consent to treatment”.

In FIGS. 8, 1 described in a cell in a table in which the topic is the column item TS and the section is the row item PS indicates that the topic is associated with the section. For example, the topic T1 “disease name/disease state” is associated with the section P1 “Your disease name and disease state”. Thus, the relationship between the section and the topic may be one-to-one. Furthermore, for example, the topic T3 “surgery content”, the topic T4 “discharge from hospital after surgery”, and the topic T5 “complications” are associated with the section P3 “Contents and precautions of surgery”. Thus, the relationship between the section and the topic may be one-to-many. Furthermore, for example, the topic T2 “treatment purpose/alternative treatment” is associated with any of the section P2 “purpose/necessity/effectiveness of surgery and alternative treatment”, the section P6 “options other than the above”, and the section P7 “in a case of withdrawing consent to treatment”. Thus, the relationship between the section and the topic may be many-to-one.

The relationship information may be defined in advance or may be estimated using an estimation model. For example, such an estimation model may be a model machine learned in such a way as to output a relevant section among the sections P1 to P7 with each of the topics T1 to T8 as an input.

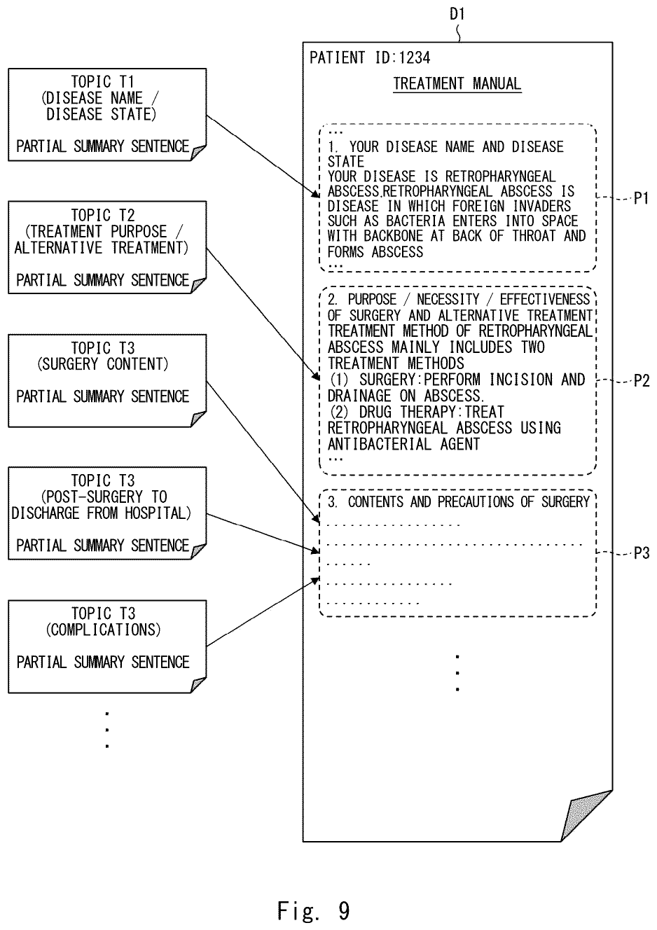

Furthermore, in step S107, the medical report is generated based on the partial summary sentence of each of the topics T1 to T8 with reference to the relationship information described above. FIG. 9 is a diagram schematically illustrating an example of a medical report in the present application example.

In FIG. 9, a medical report D1 includes a plurality of sections P1, P2, P3, . . . .

The section P1 includes a title “Your disease name and disease state” and a partial summary sentence of the topic T1 “disease name/disease state” associated with the section P1 in the relationship information. The section P2 includes a title “purpose/necessity/effectiveness of surgery and alternative treatment” and a partial summary sentence of the topic T2 “treatment purpose/alternative treatment” associated with the section P2 in the relationship information. The section P3 includes a title of “contents and precautions of surgery”, and partial summary sentences of a topic T3 “surgery content”, a topic T4 “discharge from hospital after surgery”, and a topic T5 “complications” associated with the section P3 in the relationship information.

As described above, in the present application example, it is possible to generate a medical report conforming to a predetermined format of a treatment manual from a conversation history between a doctor and a patient as well as his/her family.

### Effects of Information Processing System 100a

As described above, in the information processing system 100A, a configuration is adopted in which the summary document is a document conforming to a predetermined format including a plurality of sections, and the generation unit 13 generates the summary document with reference to the relationship information indicating the relationship between at least one of the plurality of topics and at least one of the plurality of sections. Therefore, according to the information processing system 100A, in addition to the effect obtained by the information processing apparatus 1, an effect is obtained in that a summary document conforming to a predetermined format can be generated from a conversation history.

Furthermore, in the information processing system 100A, a configuration is adopted in that a first extraction unit 14 for extracting a keyword from the partial conversation history is further provided, and the summarization unit 12 generates a partial summary sentence based on the partial conversation history and the keyword. Therefore, according to the information processing system 100A, in addition to the effects obtained by the information processing apparatus 1, an effect is obtained in that a partial summary sentence in which the partial conversation history for each topic is more appropriately summarized can be generated.

Furthermore, in the information processing system 100A, a configuration is adopted in which the estimation unit 11 estimates a plurality of topics based on the conversation history and estimates the partial conversation history for each of the plurality of estimated topics. Therefore, according to the information processing system 100A, in addition to the effect obtained by the information processing apparatus 1, an effect is obtained in that a more appropriate summary document can be generated in consideration of a topic actually existing in the conversation history.

Furthermore, in the information processing system 100A, a configuration is adopted in which the estimation unit 11 estimates to which of a plurality of topics each utterance included in the conversation history is related, and estimates, as the partial conversation history, the utterances whose estimated topics are the same. Therefore, according to the information processing system 100A, in addition to the effect obtained by the information processing apparatus, an effect is obtained in which a partial conversation history regarding each topic can be more appropriately generated from the conversation history.

### Third Exemplary Example Embodiment

A third exemplary example embodiment that is an example of an example embodiment of the present invention will be described in detail with reference to the drawings. Components that have the same functions as those of the components described in the above-described exemplary example embodiment are denoted by the same reference signs, and will not be described as appropriate. An application range of each technique adopted in the present exemplary example embodiment is not limited to the present exemplary example embodiment. That is, each technique adopted in the present exemplary example embodiment can also be adopted in another exemplary example embodiment included in the present disclosure within a range in which no particular technical problem occurs. Each technique illustrated in each of the drawings referred to for describing the present exemplary example embodiment can be adopted in the other exemplary example embodiments included in the present disclosure within a range in which no particular technical problem occurs.

### Outline of Information Processing System 100B

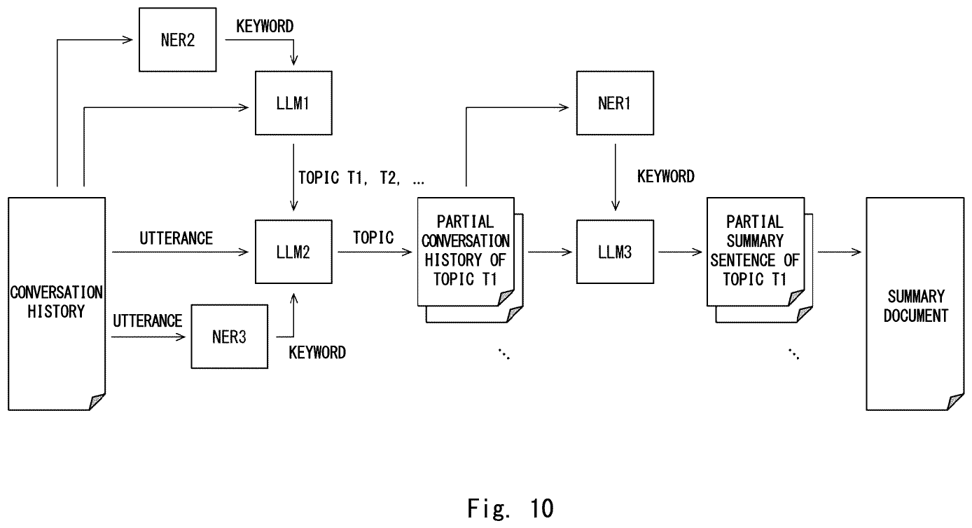

An information processing system 100B is an aspect in which the information processing system 100A is modified in such a way as to more accurately estimate the partial conversation history. FIG. 10 is a diagram schematically illustrating an outline of the information processing system 100B. FIG. 10 is substantially similar to the outline of the information processing system 100A illustrated in FIG. 3, but is different in that the keyword extracted by the named entity recognition model NER2 is input in addition to the conversation history with respect to the large-scale language model LLM1 for estimating a plurality of topics T1, T2, . . . . Furthermore, the present example embodiment is different in that the keyword extracted by the named entity recognition model NER3 is input in addition to the utterance with respect to the large-scale language model LLM2 for estimating a topic related to the utterance. The other points are as described with reference to FIG. 3, and thus detailed description will not be repeated.

### Configuration of Information Processing System 100B

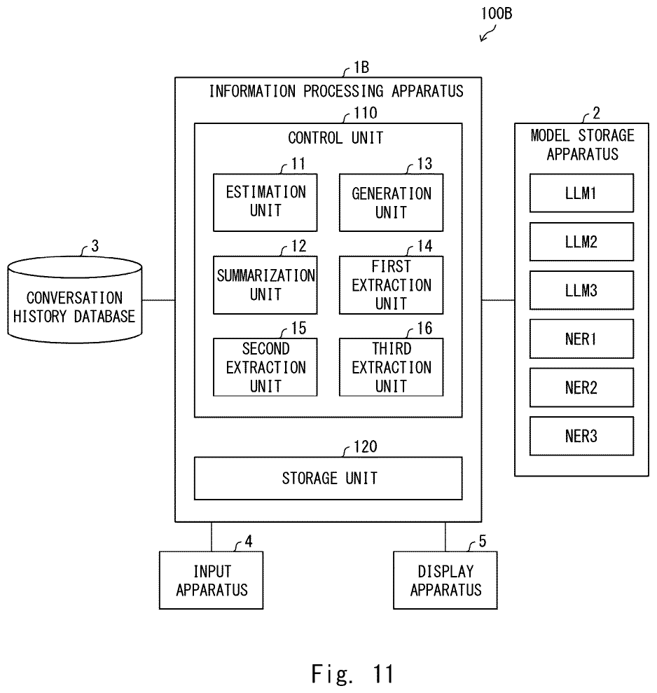

A configuration of the information processing system 100B will be described with reference to FIG. 11. FIG. 11 is a block diagram illustrating the configuration of the information processing system 100B. As illustrated in FIG. 11, the information processing system 100B is configured substantially similarly to the information processing system 100A illustrated in FIG. 4, but is different in including an information processing apparatus 1B instead of the information processing apparatus 1A. In addition, the difference also lies in that the named entity recognition models NER2 and NER3 are further stored in the model storage apparatus 2. Details of the named entity recognition models NER2 and NER3 will be described similarly to the named entity recognition model NER1. At least two of the named entity recognition models NER1, NER2, and NER3 may be different models or may be the same model. In the case of different models, a model obtained by fine-tuning the same general-purpose named entity recognition model with different training data may be used, or different general-purpose named entity recognition models may be used as the at least two models.

The information processing apparatus 1B further includes a second extraction unit 15 and a third extraction unit 16 in the control unit 110 in addition to the configuration similar to that of the information processing apparatus 1A. The second extraction unit 15 is an example of a configuration for implementing a second extraction means. The third extraction unit 16 is an example of a configuration for implementing a third extraction means.

The second extraction unit 15 extracts a keyword from the conversation history. For example, the second extraction unit 15 may extract a keyword from the conversation history by using the named entity recognition model NER2. In other words, the named entity output by inputting the conversation history to the named entity recognition model NER2 is extracted as the keyword in the conversation history.

The third extraction unit 16 extracts a keyword from each utterance included in the conversation history. For example, the third extraction unit 16 may extract a keyword from each utterance by using the named entity recognition model NER3. In other words, the named entity output by inputting a certain utterance to the named entity recognition model NER3 is extracted as the keyword in the utterance.

The estimation unit 11 is configured as follows in addition to being configured similar to that in the second exemplary example embodiment. The estimation unit 11 estimates a plurality of topics in the conversation history based on the conversation history and the keyword extracted from the conversation history. For example, the estimation unit 11 may estimate a plurality of topics to be output by inputting a prompt including a conversation history, a keyword extracted from the conversation history, and an estimation instruction of a plurality of topics to the large-scale language model LLM1.

Furthermore, the estimation unit 11 estimates which of a plurality of topics the utterance relates to, based on each utterance included in the conversation history and the keyword extracted for the utterance. For example, the estimation unit 11 may estimate the topic of the utterance by inputting a prompt including one utterance, a keyword extracted from the utterance, and an estimation instruction as to which of a plurality of topics the utterance is, to the large-scale language model LLM2.

### Flow of Information Processing Method S1B

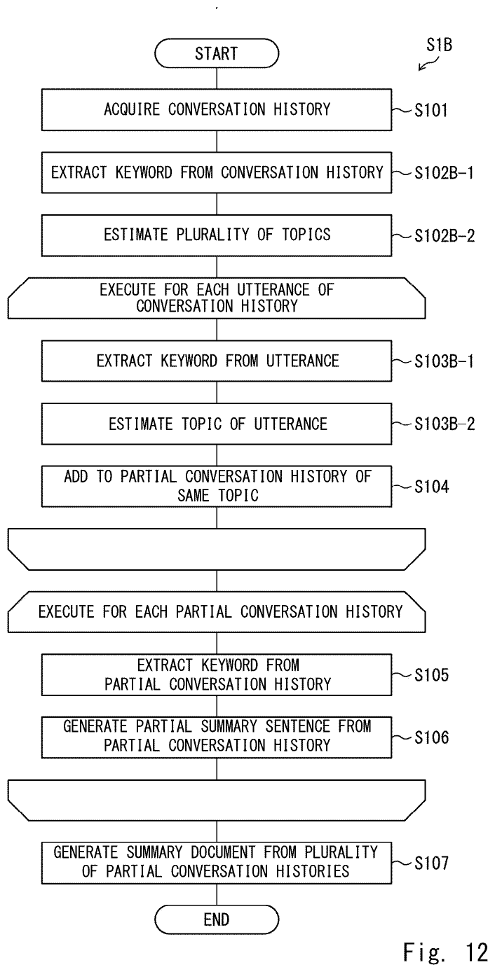

The information processing system 100B configured as described above executes an information processing method S1B. FIG. 12 is a flowchart illustrating a flow of the information processing method S1B. As illustrated in FIG. 12, the information processing method S1B includes substantially similar steps as the information processing method S1A illustrated in FIG. 5, but includes steps S102B-1 and S102B-2 instead of step S102, and steps S103B-1 and S103B-2 instead of step S103. The other points are as described with reference to FIG. 5, and thus detailed description will not be repeated.

Step S102B-1 is an example of a second extraction processing. In step S102B-1, the second extraction unit 15 extracts a keyword from the conversation history by using the named entity recognition model NER2.

In step S102B-2, the estimation unit 11 estimates a plurality of topics based on the conversation history and the keyword extracted from the conversation history by using the large-scale language model LLM1.

Step S103B-1 is an example of a third extraction processing. In step S103B-1, the third extraction unit 16 extracts a keyword from each utterance included in the conversation history by using the named entity recognition model NER3.

In step S103B-2, the estimation unit 11 estimates a topic related to the utterance based on each utterance and the keyword extracted from the utterance by using the large-scale language model LLM2.

### Effects of Information Processing System 100b

As described above, in the information processing system 100B, a configuration is adopted in that a second extraction unit 15 for extracting a keyword from the conversation history is further provided, and the estimation unit 11 estimates a plurality of topics based on the conversation history and the keyword. Therefore, according to the information processing system 100B, in addition to the effect obtained by the information processing system 100A, an effect is obtained in that a plurality of topics for generating the summary document can be more appropriately estimated.

Furthermore, in the information processing system 100B, a configuration is adopted in that a third extraction unit 16 for extracting a keyword from each utterance included in the conversation history is further provided, and the estimation unit 11 estimates to which of a plurality of topics the utterance relates based on the utterance and the keyword.

Therefore, according to the information processing system 100B, in addition to the effect obtained by the information processing system 100A, an effect is obtained in that the partial conversation history adapted to each of the plurality of topics for generating the summary document can be more appropriately estimated.

### Fourth Exemplary Example Embodiment

A fourth exemplary example embodiment that is an example of an example embodiment of the present invention will be described in detail with reference to the drawings. Components that have the same functions as those of the components described in the above-described exemplary example embodiment are denoted by the same reference signs, and will not be described as appropriate. An application range of each technique adopted in the present exemplary example embodiment is not limited to the present exemplary example embodiment. That is, each technique adopted in the present exemplary example embodiment can also be adopted in another exemplary example embodiment included in the present disclosure within a range in which no particular technical problem occurs. Each technique illustrated in each of the drawings referred to for describing the present exemplary example embodiment can be adopted in the other exemplary example embodiments included in the present disclosure within a range in which no particular technical problem occurs.

### Outline of Information Processing System 100C

An information processing system 100C is an aspect obtained by modifying the information processing system 100A in such a way as to generate a summary document from a conversation history acquired based on voice data input via a voice input apparatus.

### Configuration of Information Processing System 100C

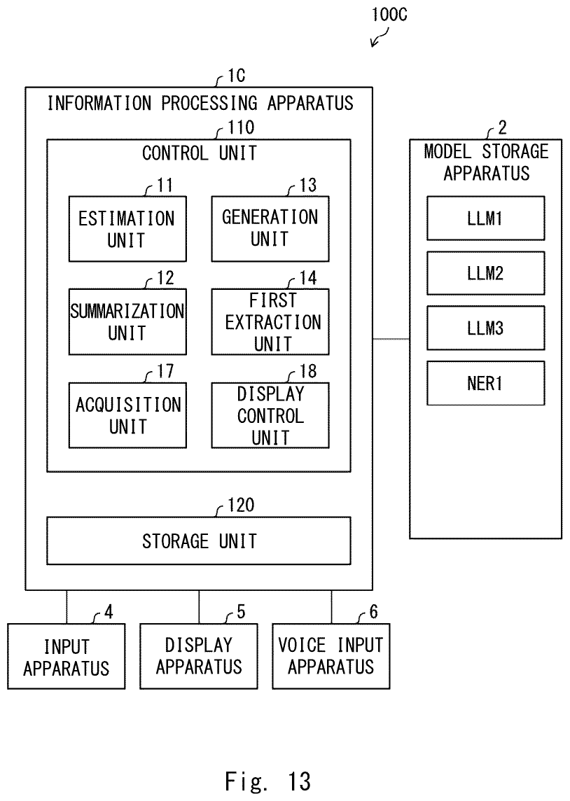

A configuration of the information processing system 100C will be described with reference to FIG. 13. FIG. 13 is a block diagram illustrating a configuration of the information processing system 100C. As illustrated in FIG. 13, the information processing system 100C is configured substantially similar to the information processing system 100A illustrated in FIG. 4, but is different in including an information processing apparatus 1C instead of the information processing apparatus 1A and including a voice input apparatus 6. Furthermore, unlike the information processing system 100A, the information processing system 100C does not necessarily include the conversation history database 3.

The voice input apparatus 6 may be, for example, a microphone. Furthermore, the voice input apparatus 6 may be connected to the information processing apparatus 1C via an input/output interface, or may be built in. In addition, the voice input apparatus 6 may be connected to or built in a user terminal (not illustrated), and the user terminal may be communicably connected to the information processing apparatus 1C via a network.

The information processing apparatus 1C further includes an acquisition unit 17 and a display control unit 18 in the control unit 110 in addition to the configuration similar to that of the information processing apparatus 1A. The acquisition unit 17 is an example of a configuration for implementing an acquisition means. The display control unit 18 is an example of a configuration for implementing a display control means.

The acquisition unit 17 acquires the conversation history based on the voice data input via the voice input apparatus 6. For example, the acquisition unit 17 may acquire text data obtained by converting voice data using a voice recognition technology as a conversation history. Furthermore, for example, the acquisition unit 17 may acquire a sequence of text data in units of utterance as the conversation history by using a technique for identifying a speaker in the voice data. Furthermore, for example, the acquisition unit 17 may update the conversation history based on the voice data continuously input for an ongoing conversation. In other words, the acquisition unit 17 may acquire the conversation history in real time.

For example, in a case where the conversation history is updated, the estimation unit 11, the summarization unit 12, the generation unit 13, and the first extraction unit 14 may update the summary document by functioning again. For example, the estimation unit 11, the summarization unit 12, the generation unit 13, and the first extraction unit 14 may function at every predetermined timing (e.g., every minute, etc.), may function each time the conversation history increases by a predetermined amount, or may function each time a new topic is added to the conversation history.

The display control unit 18 displays the summary document on the display apparatus 5. For example, in a case where the summary document is updated in accordance with the update of the conversation history, the display control unit 18 may display the updated summary document on the display apparatus 5.

### Application Example

The information processing system 100C can be used to generate a medical report (an example of a summary document) in real time in a case where a conversation between a doctor, and a patient as well as his/her family is performed. In the present application example, for example, the doctor can confirm the medical report displayed on the display apparatus 5 while having a conversation with the patient and his/her family. In addition, in a case where the section required for the displayed medical report is missing, the doctor can continue the conversation with the topic associated with the missing section.

### Effects of Information Processing System 100C

As described above, in the information processing system 100C, a configuration is adopted in which the acquisition unit 17 for acquiring the conversation history based on the voice data input via the voice input apparatus 6, and the display control unit 18 for displaying the summary document on the display apparatus 5 are further provided. Therefore, according to the information processing system 100C, in addition to the effect obtained by the information processing system 100A, an effect is obtained in that the user can generate an appropriate summary document by making a conversation among a plurality of speakers in such a way as to be input to the voice input apparatus 6. In addition, an effect is obtained in that in a case where the acquisition of the conversation history and the generation of the summary document are performed in real time, at least one of the plurality of speakers can confirm the summary document while making the conversation. Furthermore, an effect is obtained in that at least one of the plurality of speakers can continue the conversation in such a way that the displayed summary document approaches the desired content.

### Modified Examples

The information processing system 100C according to the above-described fourth exemplary example embodiment may include the information processing apparatus 1 or 1B modified to include the acquisition unit 17 and the display control unit 18 instead of the information processing apparatus 1C.

Furthermore, the information processing apparatus 1B according to the above-described third exemplary example embodiment may not include all of the first extraction unit 14, the second extraction unit 15, and the third extraction unit 16, and may be modified to include at least one thereof.

For example, the information processing apparatus 1B may include the first extraction unit 14 and the second extraction unit 15 and may not include the third extraction unit 16. In this case, the estimation unit 11 estimates a topic related to the utterance by inputting each utterance included in the conversation history to the large-scale language model LLM2.

For example, the information processing apparatus 1B may include the first extraction unit 14 and the third extraction unit 16 and may not include the second extraction unit 15. In this case, the estimation unit 11 estimates a plurality of topics related to the conversation history by inputting the conversation history to the large-scale language model LLM1.

For example, the information processing apparatus 1B may include the third extraction unit 16 and may not include the first extraction unit 14 and the second extraction unit 15. In this case, the estimation unit 11 estimates a plurality of topics related to the conversation history by inputting the conversation history to the large-scale language model LLM1. Furthermore, the summarization unit 12 generates a partial summary sentence summarizing the partial conversation history by inputting the partial conversation history to the large-scale language model LLM3.

Furthermore, in the second to fourth exemplary example embodiments described above, the summary document may not necessarily be a document conforming to a predetermined format. In addition, each of the exemplary example embodiments is not limited to the medical field, and can be applied to generate a summary document from a conversation performed between a service providing side and a service receiving side. Such fields include, but are not limited to, call centers, financial institutions, and the like.

### Example of Implementation by Software

Some or all of the functions of each of the apparatuss (hereinafter, also referred to as “each of the above apparatuss”) constituting the information processing apparatus 1 and the information processing systems 100A, 100B, and 100C may be implemented by hardware such as an integrated circuit (IC chip) or may be implemented by software.

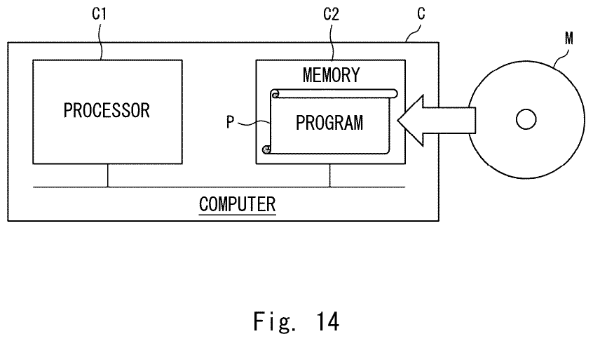

In the latter case, each of the above apparatuss is implemented by, for example, a computer that executes commands of a program, that is software for implementing each function. An example of such a computer (hereinafter, referred to as a computer C) is illustrated in FIG. 14. FIG. 14 is a block diagram illustrating a hardware configuration of the computer C functioning as each of the above apparatuss.

The computer C includes at least one processor C1 and at least one memory C2. A program P for causing the computer C to operate as each of the above apparatuss is recorded in the memory C2. In the computer C, the processor C1 reads the program P from the memory C2 and executes the program P to implement each function of each of the above apparatuss.

As the processor C1, for example, a Central Processing Unit (CPU), a Graphic Processing Unit (GPU), a Digital Signal Processor (DSP), a Micro Processing Unit (MPU), a Floating point number Processing Unit (FPU), a Physics Processing Unit (PPU), a Tensor Processing Unit (TPU), a quantum processor, a microcontroller, or a combination thereof can be used. As the memory C2, for example, a flash memory, a Hard Disk Drive (HDD), a Solid State Drive (SSD), or a combination thereof can be used.

The computer C may further include a Random Access Memory (RAM) for loading the program P at the time of execution and temporarily storing various types of data. The computer C may further include a communication interface for transmitting and receiving data to and from another apparatus. The computer C may further include an input/output interface for connecting input/output apparatuss such as a keyboard, a mouse, a display, and a printer.

The program P can be recorded in a non-transitory tangible recording medium M readable by the computer C. As such a recording medium M, for example, a tape, a disk, a card, a semiconductor memory, a programmable logic circuit, or the like can be used.

The computer C can acquire the program P via such a recording medium M. The program P can be transmitted via a transmission medium. As such a transmission medium, for example, a communication network, a broadcast wave, or the like can be used. The computer C can also acquire the program P via such a transmission medium.

Each of the above functions of each of the above apparatuss may be achieved by a single processor provided in a single computer, may be achieved in cooperation with a plurality of processors provided in a single computer, or may be achieved in cooperation with a plurality of processors provided in each of a plurality of computers. The program for causing each of the above apparatuss to achieve each of the above functions may be stored in a single memory provided in a single computer, may be stored in a distributed manner in a plurality of memories provided in a single computer, or may be stored in a distributed manner in a plurality of memories provided in each of a plurality of computers.

### Supplementary Information A

The present disclosure includes the techniques described in the following supplementary notes. However, the present invention is not limited to the techniques described in the following supplementary notes, and various modifications can be made within the scope described in the Claims.

### Supplementary Note A1

An information processing apparatus including
an estimation means for estimating, for each of a plurality of topics in a conversation history, a partial conversation history related to the topic in the conversation history,
a summarization means for generating a partial summary sentence from the partial conversation history, and
a generation means for generating a summary document of the conversation history based on the partial summary sentence for each of the plurality of topics.

### Supplementary Note A2

The information processing apparatus according to supplementary note A1, in which
the summary document is a document conforming to a predetermined format including a plurality of sections, and
the generation means generates the summary document with reference to relationship information indicating a relationship between at least one of the plurality of topics and at least one of the plurality of sections.

### Supplementary Note A3

The information processing apparatus according to supplementary note A1 or A2, further including a first extraction means for extracting a keyword from the partial conversation history,
in which the summarization means generates the partial summary sentence based on the partial conversation history and the keyword.

### Supplementary Note A4

The information processing apparatus according to any one of supplementary notes A1 to A3, in which the estimation means estimates the plurality of topics based on the conversation history, and estimates the partial conversation history for each of the plurality of estimated topics.

### Supplementary Note A5

The information processing apparatus according to supplementary note A4, further including a second extraction means for extracting a keyword from the conversation history,
in which the estimation means estimates the plurality of topics based on the conversation history and the keyword.

### Supplementary Note A6

The information processing apparatus according to any one of supplementary notes A1 to A5, in which the estimation means estimates which of the plurality of topics each utterance included in the conversation history is related to, and estimates, as the partial conversation history, the utterances whose estimated topics are the same.

### Supplementary Note A7

The information processing apparatus according to supplementary note A6, further including a third extraction means for extracting a keyword from each utterance,
in which the estimation means estimates which of the plurality of topics the utterance relates to, based on the utterance and the keyword.

### Supplementary Note A8

The information processing apparatus according to any one of supplementary notes A1 to A7, further including,

an acquisition means for acquiring the conversation history based on voice data input via a voice input apparatus, and

a display control means for displaying the summary document on a display apparatus.

### Supplementary Information B

The present disclosure includes the techniques described in the following supplementary notes. However, the present invention is not limited to the techniques described in the following supplementary notes, and various modifications can be made within the scope described in the Claims.

### Supplementary Note B1

An information processing method including,

estimation processing in which at least one processor estimates, for each of a plurality of topics in a conversation history, a partial conversation history related to the topic in the conversation history,

summarization processing in which the at least one processor generates a partial summary sentence from the partial conversation history, and

generation processing in which the at least one processor generates a summary document of the conversation history based on the partial summary sentence for each of the plurality of topics.

### Supplementary Note B2

The information processing method according to supplementary note B1, in which
the summary document is a document conforming to a predetermined format including a plurality of sections, and
in the generation processing, the at least one processor generates the summary document with reference to relationship information indicating a relationship between at least one of the plurality of topics and at least one of the plurality of sections.

### Supplementary Note B3

The information processing method according to supplementary note B1 or B2, further including first extraction processing in which the at least one processor extracts a keyword from the partial conversation history,
in which in the summarization processing, the at least one processor generates the partial summary sentence based on the partial conversation history and the keyword.

### Supplementary Note B4

The information processing method according to any one of supplementary notes B1 to B3, in which in the estimation processing, the at least one processor estimates the plurality of topics based on the conversation history, and estimates the partial conversation history for each of the plurality of estimated topics.

### Supplementary Note B5

The information processing method according to supplementary note B4, further including second extraction processing in which the at least one processor extracts a keyword from the conversation history,
in which in the estimation processing, the at least one processor estimates the plurality of topics based on the conversation history and the keyword.

### Supplementary Note B6

The information processing method according to any one of supplementary notes B1 to B5, in which in the estimation processing, the at least one processor estimates which of the plurality of topics each utterance included in the conversation history is related to, and estimates, as the partial conversation history, the utterances whose estimated topics are the same.

### Supplementary Note B7

The information processing method according to supplementary note B6, further including third extraction processing in which the at least one processor extracts a keyword from each utterance,
in which in the estimation processing, the at least one processor estimates which of the plurality of topics the utterance relates to, based on the utterance and the keyword.

### Supplementary Note B8

The information processing method according to any one of supplementary notes B1 to B7, further including,
acquisition processing in which the at least one processor acquires the conversation history based on voice data input via a voice input apparatus, and
display control processing in which the at least one processor displays the summary document on a display apparatus.

### Supplementary Information C

The present disclosure includes the techniques described in the following supplementary notes. However, the present invention is not limited to the techniques described in the following supplementary notes, and various modifications can be made within the scope described in the Claims.

### Supplementary Note C1

An information processing program for causing a computer to function as an information processing apparatus, the program causing the computer to function as,
an estimation means for estimating, for each of a plurality of topics in a conversation history, a partial conversation history related to the topic in the conversation history,
a summarization means for generating a partial summary sentence from the partial conversation history, and
a generation means for generating a summary document of the conversation history based on the partial summary sentence for each of the plurality of topics.

### Supplementary Note C2

The information processing program according to supplementary note C1, in which
the summary document is a document conforming to a predetermined format including a plurality of sections, and
the generation means generates the summary document with reference to relationship information indicating a relationship between at least one of the plurality of topics and at least one of the plurality of sections.

### Supplementary Note C3

The information processing program according to supplementary note C1 or C2, further causing the computer to function as a first extraction means for extracting a keyword from the partial conversation history,
in which the summarization means generates the partial summary sentence based on the partial conversation history and the keyword.

### Supplementary Note C4

The information processing program according to any one of supplementary notes C1 to C3, in which the estimation means estimates the plurality of topics based on the conversation history, and estimates the partial conversation history for each of the plurality of estimated topics.

### Supplementary Note C5

The information processing program according to supplementary note C4, further causing the computer to function as a second extraction means for extracting a keyword from the conversation history,

in which the estimation means estimates the plurality of topics based on the conversation history and the keyword.

### Supplementary Note C6

The information processing program according to any one of supplementary notes C1 to C5, in which the estimation means estimates which of the plurality of topics each utterance included in the conversation history is related to, and estimates, as the partial conversation history, the utterances whose estimated topics are the same.

### Supplementary Note C7

The information processing program according to supplementary note C6, further causing the computer to function as a third extraction means for extracting a keyword from each utterance,
in which the estimation means estimates which of the plurality of topics the utterance relates to, based on the utterance and the keyword.

### Supplementary Note C8

The information processing program according to any one of supplementary notes C1 to C7, further causing the computer to function as
an acquisition means for acquiring the conversation history based on voice data input via a voice input apparatus, and
a display control means for displaying the summary document on a display apparatus.

### Supplementary Information D

The present disclosure includes the techniques described in the following supplementary notes. However, the present invention is not limited to the techniques described in the following supplementary notes, and various modifications can be made within the scope described in the Claims.

### Supplementary Note D1

An information processing apparatus including at least one processor,
in which the at least one processor executes,
estimation processing of estimating, for each of a plurality of topics in a conversation history, a partial conversation history related to the topic in the conversation history,
summarization processing of generating a partial summary sentence from the partial conversation history, and
generation processing of generating a summary document of the conversation history based on the partial summary sentence for each of the plurality of topics.

The information processing apparatus may further include a memory. The memory may store a program for causing the at least one processor to execute each of the processing.

### Supplementary Note D2

The information processing apparatus according to supplementary note D1, in which
the summary document is a document conforming to a predetermined format including a plurality of sections, and
in the generation processing, the at least one processor generates the summary document with reference to relationship information indicating a relationship between at least one of the plurality of topics and at least one of the plurality of sections.

### Supplementary Note D3

The information processing apparatus according to supplementary note D1 or D2, in which

the at least one processor further executes first extraction processing of extracting a keyword from the partial conversation history, and

in the summarization processing, the at least one processor generates the partial summary sentence based on the partial conversation history and the keyword.

### Supplementary Note D4

The information processing apparatus according to any one of supplementary notes D1 to D3, in which in the estimation processing, the at least one processor estimates the plurality of topics based on the conversation history, and estimates the partial conversation history for each of the plurality of estimated topics.

### Supplementary Note D5

The information processing apparatus according to supplementary note D4, in which
the at least one processor further executes second extraction processing of extracting a keyword from the conversation history, and
in the estimation processing, the at least one processor estimates the plurality of topics based on the conversation history and the keyword.

### Supplementary Note D6

The information processing apparatus according to any one of supplementary notes D1 to D5, in which in the estimation processing, the at least one processor estimates which of the plurality of topics each utterance included in the conversation history is related to, and estimates, as the partial conversation history, the utterances whose estimated topics are the same

### Supplementary Note D7

The information processing apparatus according to supplementary note D6, in which
the at least one processor further executes third extraction processing of extracting a keyword from each utterance, and
in the estimation processing, the at least one processor estimates which of the plurality of topics the utterance relates to, based on the utterance and the keyword.

### Supplementary Note D8

The information processing apparatus according to any one of supplementary notes D1 to D7, in which the at least one processor further executes,
acquisition processing of acquiring the conversation history based on voice data input via a voice input apparatus, and
display control processing of displaying the summary document on a display apparatus.

### Supplementary Information E

The present disclosure includes the techniques described in the following supplementary notes. However, the present invention is not limited to the techniques described in the following supplementary notes, and various modifications can be made within the scope described in the Claims.

### Supplementary Note E1

A non-transitory recording medium recorded with an information processing program for causing a computer to function as an information processing apparatus, the information processing program causing the computer to execute,
estimation processing of estimating, for each of a plurality of topics in a conversation history, a partial conversation history related to the topic in the conversation history,
summarization processing of generating a partial summary sentence from the partial conversation history, and
generation processing of generating a summary document of the conversation history based on the partial summary sentence for each of the plurality of topics.

1. An information processing apparatus comprising:
at least one memory that is configured to store instructions; and
at least one processor that is configured to execute the instructions to:
estimate, for each of a plurality of topics in a conversation history, a partial conversation history related to the topic in the conversation history;
generate a partial summary sentence from the partial conversation history; and
generate a summary document of the conversation history based on the partial summary sentence for each of the plurality of topics.

2. The information processing apparatus according to claim 1,
wherein the summary document is a document conforming to a predetermined format including a plurality of sections, and
wherein the generation of the summary document includes generating the summary document with reference to relationship information indicating a relationship between at least one of the plurality of topics and at least one of the plurality of sections.

3. The information processing apparatus according to claim 1,
wherein the at least one processor is configured further to extract a keyword from the partial conversation history,
wherein the generation of the partial summary sentence includes generating the partial summary sentence based on the partial conversation history and the keyword.

4. The information processing apparatus according to claim 1, wherein the estimation of the keyword includes: estimating the plurality of topics based on the conversation history; and
estimating the partial conversation history for each of the plurality of estimated topics.

5. The information processing apparatus according to claim 4,
wherein the at least one processor is configured further to extract a keyword from the conversation history, and
wherein the estimation of the keyword includes estimating the plurality of topics based on the conversation history and the keyword.

6. The information processing apparatus according to claim 1, wherein the estimation of the keyword includes: estimating which of the plurality of topics each utterance included in the conversation history is related to; and estimating, as the partial conversation history, the utterances whose estimated topics are the same.

7. The information processing apparatus according to claim 6,
wherein the at least one processor is configured further to extract a keyword from each utterance, and
wherein the estimation of the keyword includes estimating which of the plurality of topics the utterance relates to, based on the utterance and the keyword.

8. The information processing apparatus according to claim 1,
wherein the at least one processor is configured further to:
acquire the conversation history based on voice data input via a voice input apparatus; and
display the summary document on a display apparatus.

9. The information processing apparatus according to claim 2,
wherein the at least one processor is configured further to estimate the relation information by using an estimation model, which has been learned by using machine learning.

10. An information processing method performed by at least one computer, comprising:
estimating, for each of a plurality of topics in a conversation history, a partial conversation history related to the topic in the conversation history;
generating a partial summary sentence from the partial conversation history; and
generating a summary document of the conversation history based on the partial summary sentence for each of the plurality of topics.

11. The information processing method according to claim 10,
wherein the summary document is a document conforming to a predetermined format including a plurality of sections, and
wherein the generation of the summary document includes generating the summary document with reference to relationship information indicating a relationship between at least one of the plurality of topics and at least one of the plurality of sections.

12. The information processing method according to claim 10, further comprising:
extracting a keyword from the partial conversation history,
wherein the generation of the partial summary sentence includes generating the partial summary sentence based on the partial conversation history and the keyword.

13. The information processing method according to claim 10, wherein the estimation of the keyword includes: estimating the plurality of topics based on the conversation history; and
estimating the partial conversation history for each of the plurality of estimated topics.

14. The information processing method according to claim 13, further comprising:
extracting a keyword from the conversation history,
wherein the estimation of the keyword includes estimating the plurality of topics based on the conversation history and the keyword.

15. The information processing method according to claim 10, wherein the estimation of the keyword includes: estimating which of the plurality of topics each utterance included in the conversation history is related to; and estimating, as the partial conversation history, the utterances whose estimated topics are the same.

16. The information processing method according to claim 11, further comprising:
estimate the relationship information by using an estimation model, which has been learned by using machine learning.

17. A non-transitory computer-readable medium storing a program that causes at least one computer to execute:
estimating, for each of a plurality of topics in a conversation history, a partial conversation history related to the topic in the conversation history;
generating a partial summary sentence from the partial conversation history; and
generating a summary document of the conversation history based on the partial summary sentence for each of the plurality of topics.

18. The medium according to claim 17,
wherein the summary document is a document conforming to a predetermined format including a plurality of sections, and
wherein the generation of the summary document includes generating the summary document with reference to relationship information indicating a relationship between at least one of the plurality of topics and at least one of the plurality of sections.

19. The medium according to claim 17,
wherein the program causes the at least one computer further to extract a keyword from the partial conversation history, and
wherein the generation of the partial summary sentence includes generating the partial summary sentence based on the partial conversation history and the keyword.

20. The medium according to claim 17, wherein the estimation of the keyword includes:
estimating the plurality of topics based on the conversation history; and estimating the partial conversation history for each of the plurality of estimated topics.
